(19) United States
(12) Patent Application Publication
(10) Pub. No.: US 2020/0102455 A1
(43) Pub. Date: Apr. 2, 2020

(54) Thermoplastic Resin Composition and Molded Article Using the Same

(71) Applicant: Lotte Advanced Materials Co., Ltd., Yeosu-si (KR)

(72) Inventors: Myunghun KIM, Uiwang-si (KR); Keehae KWON, Uiwang-si (KR); JaeKeun HONG, Uiwang-si (KR)

(21) Appl. No.: 16/583,501

(22) Filed: Sep. 26, 2019

(30) Foreign Application Priority Data
Sep. 28, 2018 (KR) 10-2018-0116384
Jul. 16, 2019 (KR) 10-2019-0085905

(51) Int. Cl. C08L 69/00

(52) U.S. Cl. CPC C08L 69/00; C08L 2205/025; C08L 2205/035; C08L 2201/02; C08L 2201/08; C08L 2203/30; C08L 2207/53; C08L 2207/04

(57) ABSTRACT

Disclosed are a thermoplastic resin composition including about 100 parts by weight of a base resin including (A) about 80 wt % to about 90 wt % of a polycarbonate resin; (B) about 5 wt % to about 10 wt % of an aromatic vinyl-vinyl cyanide copolymer; (C) about 3 wt % to about 7 wt % of an acrylonitrile-butadiene-styrene graft copolymer; and (D) about 2 wt % to about 8 wt % of a methylmethacrylate-butadiene-styrene graft copolymer, (E) about 0.1 to 0.3 parts by weight of a phosphate-based heat stabilizer; and (F) about 5 parts by weight to about 25 parts by weight of an inorganic filler having an average particle diameter (D50) of about 1 μm to about 5 μm, and a molded article made using the same.

### CROSS-REFERENCE TO RELATED APPLICATION

This application claims priority to and the benefit of Korean Patent Application No. 10-2018-0116384 filed in the Korean Intellectual Property Office on Sep. 28, 2018, and Korean Patent Application No. 10-2019-0085905 filed in the Korean Intellectual Property Office on Jul. 16, 2019, the entire disclosure of each of which is incorporated herein by reference.

### FIELD

A thermoplastic resin composition and a molded article using the same are disclosed.

### BACKGROUND

Polycarbonate resins are widely used as one of engineering plastics in the plastic industry.

Polycarbonate resins have a glass transition temperature (Tg) reaching about 150° C. due to a bulky molecular structure such as derived from bisphenol-A and thus can have high heat resistance. Polycarbonate resins can also have flexibility and rigidity given by a carbonyl group of a carbonate group having high rotating mobility. In addition, polycarbonate is an amorphous polymer and thus can have excellent transparency characteristics.

Further, polycarbonate resin can have excellent impact resistance and compatibility with other resins.

Polycarbonate resins, however, can have low flowability and thus, may also be largely used as alloys with various resins in order to complement moldability and post processability.

Of these, a polycarbonate/acrylonitrile-butadiene-styrene copolymer (PC/ABS) alloy can have excellent durability, moldability, heat resistance, impact resistance, dimensional stability, and the like and may be applied to many fields such as electric/electronic products, automobiles, architectural materials, miscellaneous consumer products, and the like.

An inorganic filler can be added to a PC/ABS alloy in order to further enhance dimensional stability. The PC resin, however, may be decomposed by a metal ion component included in the inorganic filler, and thus appearance and impact resistance of the PC/ABS alloy may be deteriorated.

Therefore, in order to solve the above problems, there is a need for a thermoplastic resin composition with impact resistance, appearance and dimensional stability as compared with a conventional PC/ABS alloy.

### SUMMARY OF THE INVENTION

The present disclosure relates to a thermoplastic resin composition that can have improved impact resistance, appearance and dimensional stability and a molded article made using the same.

The thermoplastic resin composition includes: 100 parts by weight of a base resin including (A) about 80 wt % to about 90 wt % of a polycarbonate resin; (B) about 5 wt % to about 10 wt % of an aromatic vinyl-vinyl cyanide copolymer; (C) about 3 wt % to about 7 wt % of an acrylonitrile-butadiene-styrene graft copolymer; and (D) about 2 wt % to about 8 wt % of a methylmethacrylate-butadiene-styrene graft copolymer, (E) about 0.1 to 0.3 parts by weight of a phosphate-based heat stabilizer; and (F) about 5 parts by weight to about 25 parts by weight of an inorganic filler having an average particle diameter (D50) of about 1 μm to about 5 μm.

The (A) polycarbonate resin may have a melt flow index of about 15 g/10 min to about 25 g/10 min, measured at 300° C. under a 1.2 kg load condition in accordance with ASTM D1238.

The (B) aromatic vinyl-vinyl cyanide copolymer may be a copolymer of a monomer mixture including about 60 wt % to about 80 wt % of an aromatic vinyl compound and about 20 wt % to about 40 wt % of a vinyl cyanide compound.

The (B) aromatic vinyl-vinyl cyanide copolymer may have a weight average molecular weight of about 80,000 g/mol to about 200,000 g/mol.

The (B) aromatic vinyl-vinyl cyanide copolymer may be a styrene-acrylonitrile copolymer.

The (C) acrylonitrile-butadiene-styrene graft copolymer may have a core-shell structure including a core composed of a butadiene-based rubbery polymer and a shell formed by graft polymerization of acrylonitrile and styrene on the core.

The (C) acrylonitrile-butadiene-styrene graft copolymer may include about 30 wt % to about 60 wt % of the core and about 40 wt % to about 70 wt % of the shell based on 100 wt % of the graft copolymer.

The (C) acrylonitrile-butadiene-styrene graft copolymer may include a butadiene-based rubbery polymer having an average particle diameter of about 200 nm to about 400 nm.

The (D) methylmethacrylate-butadiene-styrene graft copolymer may have a core-shell structure including a core composed of a butadiene-based rubbery polymer and a shell formed by graft polymerization of methylmethacrylate and/or styrene on the core.

The (E) phosphate-based heat stabilizer may include dihydrogen phosphate, stearyl phosphate, trimethyl phosphate, triethyl phosphate, triphenyl phosphate, or a combination thereof.

The (F) inorganic filler may include montmorillonite, talc, kaolin, zeolite, vermiculite, aluminum oxide, silica, magnesium hydroxide, aluminum hydroxide, glass flake, or a combination thereof.

The thermoplastic resin composition may further include an additive comprising a flame retardant, a nucleating agent, a coupling agent, a glass fiber, a plasticizer, a lubricant, an antibacterial agent, a release agent, an antioxidant, an ultraviolet (UV) stabilizer, an antistatic agent, a pigment, and/or a dye.

The present disclosure also relates to a molded article made using the aforementioned thermoplastic resin composition.

The thermoplastic resin composition and the molded article made using the same can have excellent impact resistance, appearance, and dimensional stability. The thermoplastic resin composition may be used to make a wide variety of molded products, painted and/or not-painted, for example, interior and/or exterior components for automobiles.

### BRIEF DESCRIPTION OF THE DRAWINGS

FIGS. 1 to 3 are reference molded articles demonstrating different grades for evaluating initial appearance of a molded article, namely, grade 1 (FIG. 1), grade 2 (FIG. 2), and grade 3 (FIG. 3), respectively, and

FIGS. 4 to 6 are reference molded articles demonstrating different grades for evaluating thermal stability appearance of a molded article, namely grade 1 (FIG. 4), grade 2 (FIG. 5), and grade 3 (FIG. 6), respectively.

### DETAILED DESCRIPTION

The above and other aspects, features, and advantages of the present invention will become apparent from the detailed description of the following embodiments and the accompanying drawings. It should be understood that the present invention is not limited to the following embodiments and may be embodied in different ways by those skilled in the art without departing from the scope of the present invention. Rather, the embodiments are provided for complete disclosure and to provide thorough understanding of the present invention by those skilled in the art. The scope of the present invention should be defined only by the appended claims.

In the present invention, unless otherwise described, the term “average particle diameter” of a rubbery polymer refers to volume average diameter, and can be based on Z-average particle diameter measured using a dynamic light scattering (DLS) analyzer. DLS analyzers and methods for measuring Z-average particle diameter and obtaining volume average diameter from the same are well known in the art and are commercially available.

The thermoplastic resin composition includes: 100 parts by weight of a base resin including (A) about 80 wt % to about 90 wt % of a polycarbonate resin; (B) about 5 wt % to about 10 wt % of an aromatic vinyl-vinyl cyanide copolymer; (C) about 3 wt % to about 7 wt % of an acrylonitrile-butadiene-styrene graft copolymer; and (D) about 2 wt % to about 8 wt % of a methylmethacrylate-butadiene-styrene graft copolymer, (E) about 0.1 to 0.3 parts by weight of a phosphate-based heat stabilizer; and (F) about 5 parts by weight to about 25 parts by weight of an inorganic filler having an average particle diameter (D50) of about 1 μm to about 5 μm.

Hereinafter, each component of the thermoplastic resin composition is described in detail.

### (A) Polycarbonate Resin

The polycarbonate resin is a polyester having a carbonate bond, is not particularly limited, and may be any polycarbonate that is usable in a field of resin composition.

For example, the polycarbonate resin may be prepared by reacting diphenol(s) represented by Chemical Formula 1 with phosgene, halogenic acid ester, carbonate ester, or a combination thereof:

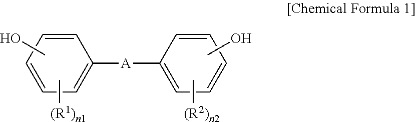

wherein in Chemical Formula 1,

A is a linking group selected from the group consisting of a single bond, a substituted or unsubstituted C1 to C30 alkylene group, a substituted or unsubstituted C2 to C5 alkenylene group, a substituted or unsubstituted C2 to C5 alkylidene group, a substituted or unsubstituted C1 to C30 haloalkylene group, a substituted or unsubstituted C5 to C6 cycloalkylene group, a substituted or unsubstituted C5 to C6 cycloalkenylene group, a substituted or unsubstituted C5 to C10 cycloalkylidene group, a substituted or unsubstituted C6 to C30 arylene group, a substituted or unsubstituted C1 to C20 alkoxylene group, a halogenic acid ester group, a carbonate ester group, CO, S, and SO₂,

R¹ and R² are independently a substituted or unsubstituted C1 to C30 alkyl group or a substituted or unsubstituted C6 to C30 aryl group, and

n1 and n2 are independently an integer ranging from 0 to 4.

Two or more types of the diphenols represented by Chemical Formula 1 may be combined to constitute a repeating unit of a polycarbonate resin.

Examples of the diphenols may include without limitation hydroquinone, resorcinol, 4,4′-dihydroxydiphenyl, 2,2-bis(4-hydroxyphenyl)propane (referred to as ‘bisphenol-A’), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3-methyl-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations and/or mixtures thereof. For example, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(3,5-dichloro-4-hydroxyphenyl)propane, and/or 1,1-bis(4-hydroxyphenyl)cyclohexane may be used, for example, 2,2-bis(4-hydroxyphenyl)propane may be used.

The polycarbonate resin may be a mixture of copolymers obtained using two or more types of diphenols that differ from each other.

In addition, the polycarbonate resin may be a linear polycarbonate resin, a branched polycarbonate resin, and/or a polyester carbonate copolymer resin, and the like.

Examples of the linear polycarbonate resin may include without limitation a bisphenol-A polycarbonate resin. Examples of the branched polycarbonate resin may include without limitation a polymer prepared by reacting a multi-functional aromatic compound such as trimellitic anhydride, trimellitic acid, and the like with diphenol(s) and a carbonate. The polyester carbonate copolymer resin may be prepared by reacting bifunctional carboxylic acid with diphenol(s) and carbonate, wherein the carbonate can be, for example, diaryl carbonate such as diphenyl carbonate and/or ethylene carbonate.

The polycarbonate resin may have a weight average molecular weight of about 10,000 g/mol to about 200,000 g/mol, for example, about 14,000 g/mol to about 40,000 g/mol. When the weight average molecular weight of the polycarbonate resin is within these ranges, excellent impact resistance and/or flowability may be obtained.

The base resin can include the polycarbonate resin in an amount of about 80 wt % to about 90 wt %, for example about 83 wt % to about 87 wt %, based on 100 wt % of the base resin. In some embodiments, the base resin can include the polycarbonate resin in an amount of about 80, 81, 82, 83, 84, 85, 86, 87, 88, 89, or 90 wt %, based on 100 wt % of the base resin. Further, according to some embodiments, the amount of the polycarbonate resin can be in a range from about any of the foregoing amounts to about any other of the foregoing amounts.

When the polycarbonate resin is present in an amount less than about 80 wt %, mechanical strength may be reduced, and when the polycarbonate resin is present in an amount greater than about 90 wt %, moldability may be reduced.

The polycarbonate resin may have a melt flow index measured at 300° C. under a 1.2 kg load condition in accordance with ASTM D1238 of greater than or equal to about 15 g/10 min, for example greater than or equal to about 16 g/10 min, and less than or equal to about 25 g/10 min, for example less than or equal to about 20 g/10 min, for example about 15 g/10 min to about 25 g/10 min, and as another example about 16 g/10 min to about 20 g/10 min. When the polycarbonate resin has a melt flow index within the above ranges, excellent impact resistance and/or flowability may be achieved.

The polycarbonate resin may include two or more polycarbonate resins with different weight average molecular weights and/or melt flow indices. The thermoplastic resin composition may be easily adjusted to achieve desired flowability by mixing polycarbonate resins having different weight average molecular weights and/or melt flow indices.

### (B) Aromatic Vinyl-Vinyl Cyanide Copolymer

The aromatic vinyl-vinyl cyanide copolymer can improve flowability of the thermoplastic resin composition and can help maintain compatibility between constituent elements.

The aromatic vinyl-vinyl cyanide copolymer may be a copolymer of an aromatic vinyl compound and a vinyl cyanide compound. The aromatic vinyl-vinyl cyanide copolymer may have a weight average molecular weight of greater than or equal to about 80,000 g/mol, for example greater than or equal to about 85,000 g/mol, and as another example greater than or equal to about 90,000 g/mol, and for example less than or equal to about 200,000 g/mol, for example less than or equal to about 150,000 g/mol, for example about 80,000 g/mol to about 200,000 g/mol, and as another example about 80,000 g/mol to about 150,000 g/mol.

The weight average molecular weight is measured by dissolving a powdery sample in tetrahydrofuran (THF) and measuring the same using 1200 series Gel Permeation Chromatography (GPC) (column is manufactured by Shodex, LF-804, standard sample is polystyrene manufactured by Shodex).

Examples of the aromatic vinyl compound may include without limitation styrene, α-methylstyrene, p-methylstyrene, p-t-butylstyrene, 2,4-dimethylstyrene, chlorostyrene, vinyltoluene, and/or vinylnaphthalene, and the like, and combinations and/or mixtures thereof.

Examples of the vinyl cyanide compound may include without limitation acrylonitrile, methacrylonitrile, and/or fumaronitrile, and the like and combinations and/or mixtures thereof.

The aromatic vinyl-vinyl cyanide copolymer may be a copolymer of a monomer mixture including the aromatic vinyl compound and the vinyl cyanide compound.

The aromatic vinyl compound may be included in an amount of for example greater than or equal to about 60 wt %, for example greater than or equal to about 65 wt %, and as another example greater than or equal to about 70 wt % and for example less than or equal to about 80 wt %, for example less than or equal to about 75 wt %, for example about 60 wt % to about 80 wt %, and as another example about 65 wt % to about 75 wt %, based on 100 wt % of the aromatic vinyl-vinyl cyanide copolymer.

In some embodiments, the aromatic vinyl-vinyl cyanide copolymer can include the aromatic vinyl compound in an amount of about 60, 61, 62, 63, 64, 65, 66, 67, 68, 69, 70, 71, 72, 73, 74, 75, 76, 77, 78, 79, or 80 wt %, based on 100 wt % of the aromatic vinyl-vinyl cyanide copolymer. Further, according to some embodiments, the amount of the aromatic vinyl compound can be in a range from about any of the foregoing amounts to about any other of the foregoing amounts.

The vinyl cyanide compound may be included in an amount of for example greater than or equal to about 20 wt %, for example greater than or equal to about 25 wt % and for example less than or equal to about 40 wt %, for example less than or equal to about 30 wt %, for example about 20 wt % to about 40 wt %, and as another example about 25 wt % to about 35 wt %, based on 100 wt % of the aromatic vinyl-vinyl cyanide copolymer.

In some embodiments, the aromatic vinyl-vinyl cyanide copolymer can include the vinyl cyanide compound in an amount of about 20, 21, 22, 23, 24, 25, 26, 27, 28, 29, 30, 31, 32, 33, 34, 35, 36, 37, 38, 39, or 40 wt %, based on 100 wt % of the aromatic vinyl-vinyl cyanide copolymer. Further, according to some embodiments, the amount of the vinyl cyanide compound can be in a range from about any of the foregoing amounts to about any other of the foregoing amounts.

The aromatic vinyl-vinyl cyanide copolymer may be a styrene-acrylonitrile copolymer (SAN).

The base resin can include the aromatic vinyl-vinyl cyanide copolymer in an amount of for example greater than or equal to about 5 wt %, for example greater than or equal to about 6 wt % and for example less than or equal to about 10 wt %, for example less than or equal to about 9 wt %, for example less than or equal to about 8 wt %, for example about 5 wt % to about 10 wt %, and for example about 6 wt % to about 8 wt %, based on 100 wt % of the base resin. In some embodiments, the base resin can include the aromatic vinyl-vinyl cyanide copolymer in an amount of about 5, 6, 7, 8, 9, or 10 wt %, based on 100 wt % of the base resin. Further, according to some embodiments, the amount of the aromatic vinyl-vinyl cyanide copolymer can be in a range from about any of the foregoing amounts to about any other of the foregoing amounts.

When the base resin includes the aromatic vinyl-vinyl cyanide copolymer in an amount less than about 5 wt %, moldability of the thermoplastic resin composition may be deteriorated, while when the base resin includes the aromatic vinyl-vinyl cyanide copolymer in an amount greater than about 10 wt %, impact resistance of the thermoplastic resin composition may be deteriorated.

### (C) Acrylonitrile-Butadiene-Styrene Graft Copolymer

The acrylonitrile-butadiene-styrene graft copolymer can impart impact resistance to the thermoplastic resin composition. The acrylonitrile-butadiene-styrene graft copolymer may have a core-shell structure including a core composed of a butadiene-based rubbery polymer component and a shell formed by graft polymerization of acrylonitrile and styrene around the core.

The rubbery polymer component of the core improves impact strength at particularly low temperatures, while the shell component reduces interface tension to improve adherence at the interface.

The acrylonitrile-butadiene-styrene graft copolymer may be prepared by adding styrene and acrylonitrile to the butadiene-based rubbery polymer and graft-copolymerizing them through conventional polymerization methods such as emulsion polymerization and massive polymerization.

Examples of the butadiene-based rubbery polymer may include without limitation a butadiene rubbery polymer, a butadiene-styrene rubbery polymer, a butadiene-acrylonitrile rubbery polymer, and/or a butadiene-acrylate rubbery polymer, and the like, and combinations and/or mixtures thereof.

The acrylonitrile-butadiene-styrene graft copolymer may include a butadiene-based rubbery polymer having an average particle diameter of for example about 200 nm to about 400 nm, for example about 200 nm to about 350 nm, and as another example about 250 nm to about 350 nm.

The base resin can include the acrylonitrile-butadiene-styrene graft copolymer in an amount of for example about 3 wt % to about 7 wt %, for example about 4 wt % to about 7 wt %, and as another example about 5 wt % to about 7 wt %, based on 100 wt % of the base resin. In some embodiments, the base resin can include the acrylonitrile-butadiene-styrene graft copolymer in an amount of about 3, 4, 5, 6, or 7 wt %, based on 100 wt % of the base resin. Further, according to some embodiments, the amount of the acrylonitrile-butadiene-styrene graft copolymer can be in a range from about any of the foregoing amounts to about any other of the foregoing amounts.

The butadiene-based rubbery polymer core may be included in an amount of about 30 wt % to about 60 wt % and the shell may be included in an amount of about 40 wt % to about 70 wt % based on 100 wt % of the acrylonitrile-butadiene-styrene graft copolymer.

In some embodiments, the acrylonitrile-butadiene-styrene graft copolymer can include the butadiene-based rubbery polymer core in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %, based on 100 wt % of the acrylonitrile-butadiene-styrene graft copolymer. Further, according to some embodiments, the amount of the butadiene-based rubbery polymer core can be in a range from about any of the foregoing amounts to about any other of the foregoing amounts.

In some embodiments, the acrylonitrile-butadiene-styrene graft copolymer can include the shell in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %, based on 100 wt % of the acrylonitrile-butadiene-styrene graft copolymer. Further, according to some embodiments, the amount of the shell can be in a range from about any of the foregoing amounts to about any other of the foregoing amounts.

The shell may be a styrene-acrylonitrile copolymer having a weight ratio of the styrene and the acrylonitrile ranging from about 6:4 to about 8:2.

When the base resin includes the acrylonitrile-butadiene-styrene graft copolymer in an amount of less than about 3 wt %, impact resistance of the thermoplastic resin composition may be deteriorated, while when the base resin includes the acrylonitrile-butadiene-styrene graft copolymer in an amount of greater than about 7 wt %, heat resistance and/or molded article appearance may be deteriorated.

### (D) Methylmethacrylate-Butadiene-Styrene Graft Copolymer

The methylmethacrylate-butadiene-styrene graft copolymer can impart impact resistance of the thermoplastic resin composition together with the aforementioned acrylonitrile-butadiene-styrene graft copolymer, and also can contribute to dimensional stability and/or appearance characteristic improvement of the molded article using the thermoplastic resin composition.

The methylmethacrylate-butadiene-styrene graft copolymer may have a core-shell structure including a core composed of a butadiene-based rubbery polymer component and a shell formed by graft polymerization of methylmethacrylate and/or styrene around the core.

The methylmethacrylate-butadiene-styrene graft copolymer may be prepared by adding methylmethacrylate and/or styrene to the butadiene-based rubbery polymer and graft-copolymerizing them through conventional polymerization methods such as emulsion polymerization and massive polymerization.

Examples of the butadiene-based rubbery polymer may include without limitation a butadiene rubbery polymer, a butadiene-styrene rubbery polymer, a butadiene-acrylonitrile rubbery polymer, and/or a butadiene-acrylate rubbery polymer, and the like, and combinations and/or mixtures thereof.

The base resin can include the methylmethacrylate-butadiene-styrene graft copolymer in an amount of about 2 wt % to about 8 wt %, for example about 2 wt % to about 6 wt %, based on 100 wt % of the base resin. In some embodiments, the base resin can include the methylmethacrylate-butadiene-styrene graft copolymer in an amount of about 2, 3, 4, 5, 6, 7, or 8 wt %, based on 100 wt % of the base resin. Further, according to some embodiments, the amount of the methylmethacrylate-butadiene-styrene graft copolymer can be in a range from about any of the foregoing amounts to about any other of the foregoing amounts.

The butadiene-based rubbery polymer core may be included in an amount of about 20 wt % to about 80 wt % and the shell may be included in an amount of about 20 wt % to about 80 wt % based on 100 wt % of the methylmethacrylate-butadiene-styrene graft copolymer.

In some embodiments, the methylmethacrylate-butadiene-styrene graft copolymer can include the butadiene-based rubbery polymer core in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %, based on 100 wt % of the methylmethacrylate-butadiene-styrene graft copolymer. Further, according to some embodiments, the amount of the butadiene-based rubbery polymer core can be in a range from about any of the foregoing amounts to about any other of the foregoing amounts.

In some embodiments, the methylmethacrylate-butadiene-styrene graft copolymer can include the shell in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %, based on 100 wt % of the methylmethacrylate-butadiene-styrene graft copolymer. Further, according to some embodiments, the amount of the shell can be in a range from about any of the foregoing amounts to about any other of the foregoing amounts.

The methylmethacrylate-butadiene-styrene graft copolymer may include a butadiene-based rubbery polymer having an average particle diameter of for example about 100 nm to about 400 nm, for example about 120 nm to about 380 nm.

When the base resin includes the methylmethacrylate-butadiene-styrene graft copolymer in an amount of less than about 2 wt %, impact resistance of the thermoplastic resin composition may be deteriorated, while when the base resin includes the methylmethacrylate-butadiene-styrene graft copolymer in an amount of greater than about 8 wt %, dimensional stability and/or appearance characteristics may be deteriorated.

### (E) Phosphate-Based Heat Stabilizer

The phosphate-based heat stabilizer can prevent a thermal decomposition reaction of the polycarbonate resin due to heat during a process of preparing a thermoplastic resin composition and/or a process of manufacturing a molded article using the thermoplastic resin composition. In addition, when an inorganic filler is added to the thermoplastic resin composition to further enforce dimensional stability, the phosphate-based heat stabilizer can reduce or prevent acceleration of thermal decomposition of the polycarbonate resin by metal ions included in the inorganic filler. The decomposition reaction of the polycarbonate resin may unfavorably cause deterioration of properties (such as impact resistance, dimensional stability, and/or appearance) of the thermoplastic resin composition. In other words, the phosphate-based heat stabilizer can suppress the thermal decomposition of the polycarbonate resin to provide the thermoplastic resin composition with thermal stability.

Examples of the phosphate-based heat stabilizer may include without limitation dihydrogen phosphate, stearyl phosphate, trimethyl phosphate, triethyl phosphate, and/or triphenyl phosphate, and the like, and combinations and/or mixtures thereof. For example, the phosphate-based heat stabilizer can include stearyl phosphate.

The thermoplastic resin composition can include the phosphate-based heat stabilizer in a relatively trace amount based on about 100 parts by weight of base resin. For example, the thermoplastic resin composition can include the phosphate-based heat stabilizer in an amount of about 0.1 parts by weight to about 0.3 parts by weight, for example about 0.1 parts by weight to about 0.2 parts by weight, based on about 100 parts by weight of the base resin. In some embodiments, the thermoplastic resin composition can include the phosphate-based heat stabilizer in an amount of about 0.1, 0.2, or 0.3 parts by weight, based on about 100 parts by weight of the base resin. Further, according to some embodiments, the amount of the phosphate-based heat stabilizer can be in a range from about any of the foregoing amounts to about any other of the foregoing amounts.

When the thermoplastic resin composition includes the phosphate-based heat stabilizer in an amount outside of the above ranges, various properties such as impact resistance and/or appearance characteristics of the thermoplastic resin composition and the molded article made using the same may be deteriorated, making it difficult to balance target properties.

### (F) Inorganic Filler

The inorganic filler may improve dimensional stability of the thermoplastic resin composition. The inorganic filler may have, for example, a particulate shape, a flake shape, and/or a fiber shape. Examples of the inorganic filler may include without limitation mica, quartz powder, titanium dioxide, silicate, alumino silicate, chalk, wollastonite, mica, layered clay mineral, montmorillonite, such as ion exchange modified organophilic montmorillonite, talc, kaolin, zeolite, vermiculite, aluminum oxide, silica, magnesium hydroxide, aluminum hydroxide, and/or a glass flake, and the like. Combinations and/or mixtures of different inorganic materials may be also used.

For example, the inorganic filler can include talc and/or mica, for example can include talc.

The inorganic filler may have an average particle diameter (D50), which is measured by a laser particle size analyzer (such as the Mastersizer 3000 manufactured by Malvern Panalytical), of, for example, greater than or equal to about 1 μm, for example greater than or equal to about 2 μm, for example greater than or equal to about 3 μm and, for example, less than or equal to about 5 μm, for example less than or equal to about 4 μm, for example, about 1 to about 5 μm, for example about 2 to about 4 μm. In some embodiments, the inorganic filler may have an average particle diameter (D50) of about 1, 2, 3, 4, or 5 μm. Further, according to some embodiments, the inorganic filler may have an average particle diameter (D50) in a range from about any of the foregoing to about any other of the foregoing.

When the average particle diameter of the inorganic filler is outside of these ranges, mechanical strength and/or appearance characteristics may be deteriorated.

The thermoplastic resin composition can include the inorganic filler in an amount of for example greater than or equal to about 5 parts by weight, for example greater than or equal to about 10 parts by weight, for example greater than or equal to about 15 parts by weight, and for example less than or equal to about 25 parts by weight, for example about 5 parts by weight to about 25 parts by weight, for example about 10 parts by weight to about 25 parts by weight, and for example about 10 parts by weight to about 20 parts by weight, based on about 100 parts by weight of the base resin. In some embodiments, the thermoplastic resin composition can include the inorganic filler in an amount of about 5, 6, 7, 8, 9, 10, 11, 12, 13, 14, 15, 16, 17, 18, 19, 20, 21, 22, 23, 24, or 25 parts by weight, based on about 100 parts by weight of the base resin. Further, according to some embodiments, the amount of the inorganic filler can be in a range from about any of the foregoing amounts to about any other of the foregoing amounts.

When the thermoplastic resin composition includes the inorganic filler in an amount outside of the above ranges, dimensional stability, heat resistance, mechanical strength, and/or appearance characteristics of the thermoplastic resin composition and the molded article made using the same may be deteriorated.

### (G) Other Additives

In addition to the components (A) to (F), the thermoplastic resin composition may further include one or more additives depending on the end use of the thermoplastic resin composition and/or to balance properties of the thermoplastic resin composition, under conditions that can satisfy heat resistance, impact resistance, dimensional stability, and/or appearance characteristics.

Examples of the additive may include without limitation a flame retardant, a nucleating agent, a coupling agent, a glass fiber, a plasticizer, a lubricant, an antibacterial agent, a release agent, an antioxidant, an ultraviolet (UV) stabilizer, an antistatic agent, a pigment, and/or a dye, and the like, which may be used alone or in a combination and/or mixture of two or more.

These additives may be suitably included within a range that does not impair properties of the thermoplastic resin composition, and in particular, may be included in an amount of less than or equal to about 20 parts by weight based on about 100 parts by weight of the base resin, but is not limited thereto.

The thermoplastic resin composition may be prepared by any well-known method of preparing a thermoplastic resin composition. For example, the thermoplastic resin composition may be manufactured into pellet form by mixing the aforementioned components (A) to (F) and other optional additives simultaneously and melt-kneading the same in an extruder.

The present disclosure also relates to a molded product manufactured from the aforementioned thermoplastic resin composition. The thermoplastic resin composition can have excellent heat resistance, impact resistance, dimensional stability, appearance, and/or moldability, so that it may be used to manufacture various molded products, including painted and/or non-painted molded products, such as but not limited to interior and/or exterior components of automobiles.

Hereinafter, the present invention is illustrated in more detail with reference to the following examples. These examples, however, are not in any sense to be interpreted as limiting the scope of the invention.

### Example 1, Example 2 and Comparative Example 1 to Comparative Example 6

Thermoplastic resin compositions according to Examples 1 and 2 and Comparative Examples 1 to 6 are prepared according to the component content ratios shown in Table 1.

In Table 1, (A), (B), (C), and (D) are included in the base resin and the amounts thereof are reported as wt % based on the total weight of the base resin including (A), (B), (C), and (D), and (E), (F), and (F′) are added into the base resin and the amounts thereof are reported as parts by weight based on 100 parts by weight of the base resin.

The components shown in Table 1 are dry-mixed and quantitatively and continuously added into a supplying part of the twin-screw extruder (L/D=29, ϕ=45 mm) and melted/kneaded. In this case, a barrel temperature of the twin-screw extruder is set at 250° C. Subsequently, thermoplastic resin composition pellets obtained through the twin-screw extruder are dried at about 100° C. for about 2 hours, and then using 6 oz injection molding device setting a cylinder temperature at about 270° C. and a mold temperature at about 60° C., a specimen for measuring impact resistance, a 50 mm (width)×200 mm (length) specimen for verifying appearance having a thickness of 2 mm, and a 10 mm (width)×15 mm (length) specimen for verifying dimensional stability having a thickness of 3 mm are each injected.

TABLE 1

| | | Exam- | Exam- | | | | | | |
|---|---|---|---|---|---|---|---|---|---|
| | | ple 1 | ple 2 | CE 1 | CE 2 | CE 3 | CE 4 | CE 5 | CE 6 |
| Base | (A) | 85 | 85 | 85 | 85 | 85 | 85 | 85 | 85 |
| resin | (B) | 6 | 6 | 6 | 7 | 6 | 6 | 6 | 6 |
| | (C) | 5 | 5 | 9 | — | 5 | 5 | 5 | 5 |
| | (D) | 4 | 4 | — | 8 | 4 | 4 | 4 | 4 |

| | | | | | | | | |
|---|---|---|---|---|---|---|---|---|
| (E) | 0.1 | 0.2 | 0.1 | 0.1 | — | 0.4 | 0.1 | 15 |
| (F) | 21 | 21 | 20 | 22 | 21 | 21 | — | 21 |
| (F′) | — | — | — | — | — | — | 21 | — |

Descriptions of the components described in Table 1 are as follows.

(A) Polycarbonate Resin

Polycarbonate resin (Lotte Advanced Materials Co., Ltd.) having a melt flow index, measured at 300° C. under a 1.2 kg load condition in accordance with ASTM D1238 of about 18 g/10 min.

(B) Aromatic Vinyl-Vinyl Cyanide Copolymer

Styrene-acrylonitrile copolymer (Lotte Advanced Materials Co., Ltd.) obtained by copolymerization of a monomer mixture including 28 wt % of acrylonitrile and 72 wt % of styrene and having a weight average molecular weight of about 100,000 g/mol.

(C) Acrylonitrile-Butadiene-Styrene Graft Copolymer

Acrylonitrile-butadiene-styrene graft copolymer (Lotte Advanced Materials Co., Ltd.) including a core composed of 45 wt % of a butadiene rubbery polymer having an average particle diameter of about 300 nm and 55 wt % of a shell which is a styrene-acrylonitrile copolymer composed of styrene and acrylonitrile in a weight ratio of 7:3.

(D) Methyl Methacrylate-Butadiene-Styrene Graft Copolymer

Methyl methacrylate-butadiene-styrene graft copolymer (Dow Inc., PARALOID) having a core-shell structure including a shell formed by graft polymerization of a methylmethacrylate on a butadiene-styrene rubbery polymer core.

(E) Phosphate-Based Heat Stabilizer

Stearyl phosphate (ADK STAB, Adeka Corp.)

(F) Inorganic Filler (Type-I)

Talc (manufactured by Imerys, JETFINE) having an average particle diameter (D50) of 3.9 μm which is measured by a laser particle size analyzer (manufactured by Malvern Panalytical, Mastersizer 3000).

(F′) Inorganic Filler (Type-II)

Talc (manufactured by Koch, KCM-6300C) having an average particle diameter (D50) of 6.5 μm which was measured by a laser particle size analyzer (manufactured by Malvern Panalytical, Mastersizer 3000).

### EXPERIMENTAL EXAMPLES

The experimental results are shown in Table 2.

(1) Impact Resistance (kgf·cm/cm): Notch Izod Impact strength is measured for a specimen having a thickness of ⅛″ each at a room temperature (23° C.) and a low temperature (−30° C.) according to ASTM D256.

(2) Dimensional Stability (μm/m·° C.): after removing stress within a temperature range of −50° C. to 130° C. in a flowing direction of a resin using a thermomechanical analyzer (manufactured by TA Instruments, Q400), a specimen for verifying dimensional stability is measured for a coefficient of linear expansion within a temperature range of −40° C. to 40° C.

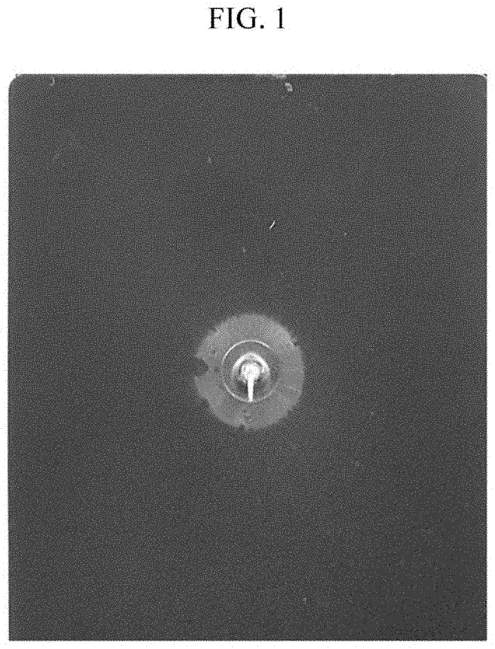

(3) Initial Appearance: initial appearance of a specimen is evaluated by measuring a gas area generated in a standard area (width: 50 mm×length: 50 mm) in a center of an injection gate disposed in the upper end center of the specimen as shown in FIGS. 1 to 3. The initial appearances of the specimens are classified as follows: grade 1—when gas is not generated in the standard area; grade 2—when gas is generated in less than or equal to ¼ of the standard area; and grade 3—when gas is generated in greater than ¼ of the standard area.

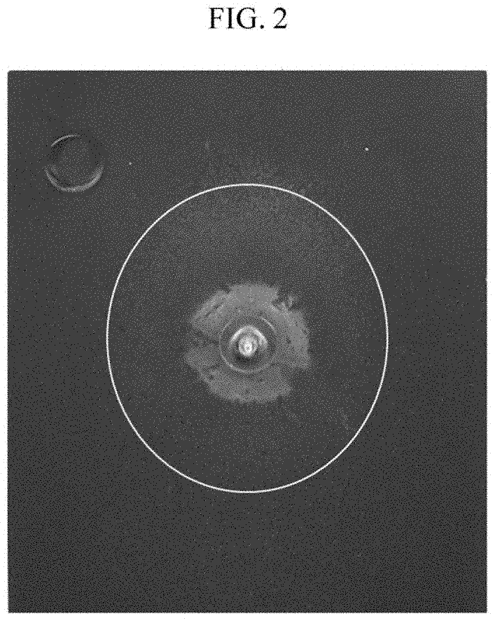

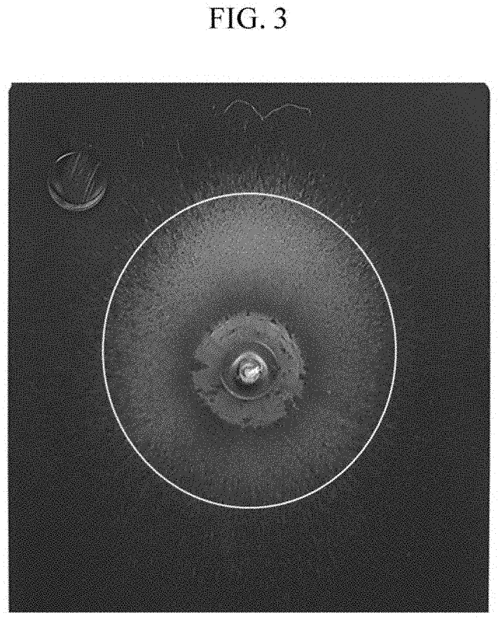

FIGS. 1 to 3 are reference molded specimens for evaluating initial appearance, made using an exemplary thermoplastic resin composition of the present invention, and illustrate grade 1 (FIG. 1), grade 2 (FIG. 2), and grade 3 (FIG. 3), respectively.

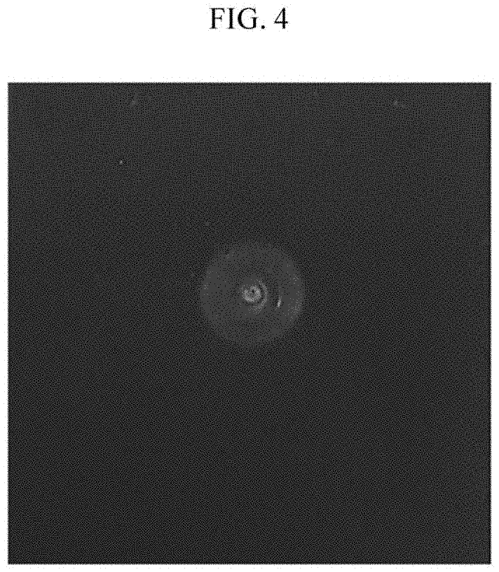

(4) Appearance after exposure to high temperature (also referred to as late appearance): after maintaining the resin composition pellets in an injection molding cylinder setting a temperature at 290° C. for 4 minutes, the appearance of a specimen is evaluated by measuring an area of gas generated in a standard area (width 50 mm×length 50 mm) in a center of an injection gate disposed in a specimen center, as shown in FIGS. 4 to 6. The appearances of the specimens after exposure to 290° C. for 4 minutes are classified as follows: grade 1—when gas is not generated in the standard area; grade 2—when gas is generated in less than or equal to ½ of the standard area; and grade 3—when gas is generated in greater than ½ of the standard area.

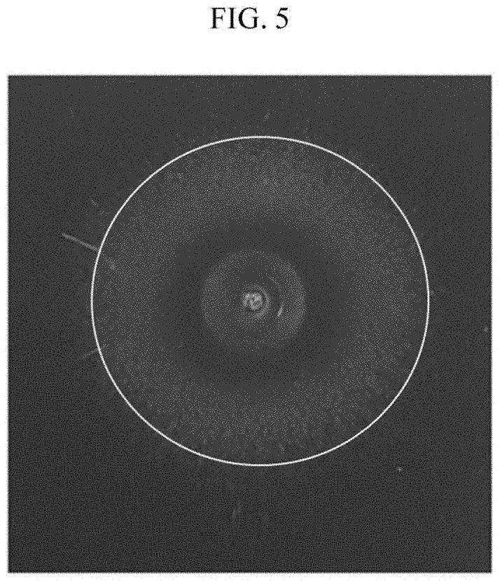

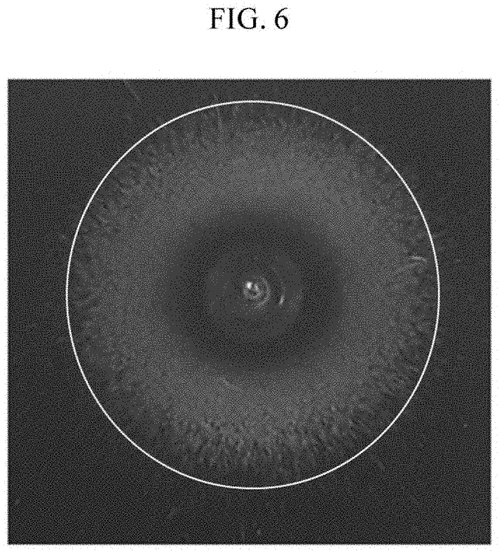

FIGS. 4 to 6 are reference molded specimens for evaluating thermal stability following exposure to 290° C. for 4 minutes, made using an exemplary thermoplastic resin composition of the present invention, and illustrate grade 1 (FIG. 4), grade 2 (FIG. 5), and grade 3 (FIG. 6), respectively.

TABLE 2

| | Example 1 | Example 2 | CE 1 | CE 2 | CE 3 | CE 4 | CE 5 | CE 6 |
|---|---|---|---|---|---|---|---|---|
| Izod (23° C.) | 12 | 18 | 12 | 8 | 9 | 18 | 8 | 4 |
| Izod (−30° C.) | 7 | 9 | 6 | 5 | 6 | 9 | 5 | 3 |
| Coefficient of linear | 43 | 43 | 40 | 45 | 43 | 43 | 44 | 55 |
| expansion | | | | | | | | |
| Initial appearance | 1 | 1 | 2 | 1 | 3 | 3 | 2 | 3 |
| Late appearance | 1 | 1 | 2 | 1 | 3 | 3 | 2 | 3 |

Referring to Tables 1 and 2, the thermoplastic resin composition and the molded article made using the same exhibit excellent impact resistance, dimensional stability, and appearance characteristics by using the polycarbonate resin, the aromatic vinyl-vinyl cyanide copolymer, the acrylonitrile-butadiene-styrene graft copolymer, the methylmethacrylate-styrene-acrylonitrile graft copolymer, the phosphate-based heat stabilizer, and the inorganic filler in appropriate amounts.

It is within the scope of this disclosure for one or more of the terms “substantially,” “about,” “approximately,” and/or the like, to qualify each adjective and adverbs of the foregoing disclosure, to provide a broad disclosure. As an example, it is believed those of ordinary skill in the art will readily understand that, in different implementations of the features of this disclosure, reasonably different engineering tolerances, precision, and/or accuracy may be applicable and suitable for obtaining the desired result. Accordingly, it is believed those of ordinary skill will readily understand usage herein of the terms such as “substantially,” “about,” “approximately,” and the like.

The use of the term “and/or” includes any and all combinations of one or more of the associated listed items.

The figures are schematic representations and so are not necessarily drawn to scale.

Exemplary embodiments have been disclosed herein, and although specific terms are employed, unless otherwise noted, they are to be interpreted in a generic and descriptive sense only and not for purpose of limitation. Also although some embodiments have been described above, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

What is claimed is:

1. A thermoplastic resin composition comprising:
about 100 parts by weight of a base resin comprising:
(A) about 80 wt % to about 90 wt % of a polycarbonate resin;
(B) about 5 wt % to about 10 wt % of an aromatic vinyl-vinyl cyanide copolymer;
(C) about 3 wt % to about 7 wt % of an acrylonitrile-butadiene-styrene graft copolymer; and
(D) about 2 wt % to about 8 wt % of a methylmethacrylate-butadiene-styrene graft copolymer;
(E) about 0.1 to 0.3 parts by weight of a phosphate-based heat stabilizer based on about 100 parts by weight of the base resin; and
(F) about 5 parts by weight to about 25 parts by weight of an inorganic filler based on about 100 parts by weight of the base resin having an average particle diameter (D50) of about 1 μm to about 5 μm.

2. The thermoplastic resin composition of claim 1, wherein the (A) polycarbonate resin has a melt flow index of about 15 g/10 min to about 25 g/10 min, measured at 300° C. under a 1.2 kg load condition in accordance with ASTM D1238.

3. The thermoplastic resin composition of claim 1, wherein the (B) aromatic vinyl-vinyl cyanide copolymer is a copolymer of a monomer mixture comprising about 60 wt % to about 80 wt % of an aromatic vinyl compound and about 20 wt % to about 40 wt % of a vinyl cyanide compound.

4. The thermoplastic resin composition of claim 1, wherein the (B) aromatic vinyl-vinyl cyanide copolymer has a weight average molecular weight of about 80,000 g/mol to about 200,000 g/mol.

5. The thermoplastic resin composition of claim 1, wherein the (B) aromatic vinyl-vinyl cyanide copolymer is a styrene-acrylonitrile copolymer.

6. The thermoplastic resin composition of claim 1, wherein the (C) acrylonitrile-butadiene-styrene graft copolymer has a core-shell structure comprising:
a core including a butadiene-based rubbery polymer, and
a shell formed by graft polymerization of acrylonitrile and styrene on the core.

7. The thermoplastic resin composition of claim 6, wherein the (C) acrylonitrile-butadiene-styrene graft copolymer comprises about 30 wt % to about 60 wt % of the core and about 40 wt % to about 70 wt % of the shell based on 100 wt % of the graft copolymer.

8. The thermoplastic resin composition of claim 1, wherein the (C) acrylonitrile-butadiene-styrene graft copolymer comprises a butadiene-based rubbery polymer having an average particle diameter of about 200 nm to about 400 nm.

9. The thermoplastic resin composition of claim 1, wherein the (D) methylmethacrylate-butadiene-styrene graft copolymer has a core-shell structure comprising:
a core including a butadiene-based rubbery polymer, and
a shell formed by graft polymerization of methylmethacrylate and/or styrene on the core.

10. The thermoplastic resin composition of claim 1, wherein the (E) phosphate-based heat stabilizer comprises dihydrogen phosphate, stearyl phosphate, trimethyl phosphate, triethyl phosphate, triphenyl phosphate, or a combination thereof.

11. The thermoplastic resin composition of claim 1, wherein the (F) inorganic filler comprises montmorillonite, talc, kaolin, zeolite, vermiculite, aluminum oxide, silica, magnesium hydroxide, aluminum hydroxide, glass flake, or a combination thereof.

12. The thermoplastic resin composition of claim 1, wherein the thermoplastic resin composition further comprises at least one additive comprising a flame retardant, a nucleating agent, a coupling agent, a glass fiber, a plasticizer, a lubricant, an antibacterial agent, a release agent, an antioxidant, an ultraviolet (UV) stabilizer, an antistatic agent, a pigment, and/or a dye.

13. A molded article made using the thermoplastic resin composition of claim 1.
